(19) United States
(12) Patent Application Publication
(10) Pub. No.: US 2010/0042936 A1
(43) Pub. Date: Feb. 18, 2010

(54) INFORMATION PROCESSING APPARATUS, PROGRAM, AND DISPLAY CONTROL METHOD

(75) Inventors: Satoru Ooga, Tokyo (JP); Kyousuke Nishiyama, Tokyo (JP); Shuji Senda, Tokyo (JP); Yushin Tatsumi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/064,439

(22) PCT Filed: Aug. 21, 2006
(86) PCT No.: PCT/JP2006/316296

§ 371 Date: Oct. 20, 2009

(30) Foreign Application Priority Data
Aug. 22, 2005 (JP) 2005-239890

(51) Int. Cl. G06F 3/00

(52) U.S. Cl. 715/764

(57) ABSTRACT

There is provided a browsing technology capable of performing a browsing operation intuitively as well as by a smaller number operations without the need of a device capable of performing a direct pointing such as a mouse in a layout arrangement reflecting the intention of a creator of a browsing document. Browsing documents are displayed at an ordinary display mode and in a zapping display mode. The ordinary display mode is a mode for displaying an entire display screen (a first display region) on which an entire HTML document, in which a browsing target is blocked, is displayed and a detail display screen (a second display region) on which the detail of the blocked HTML document is displayed. The zapping display mode is a mode for displaying a detail screen (a first display region), on which the detail of a browsing HTML document is displayed, and a thumbnail display screen (a second display region) on which the thumbnail image of a link destination of the information, from which the HTML document is selected, is displayed.

### TECHNICAL FIELD

The present invention relates to a browsing system for browsing documents of Web and like, and more particular to a browsing system capable of browsing target information intuitively as well as a smaller number of times of operation while performing a display to which the intention of a document creator is reflected.

### BACKGROUND ART

A lot of websites exist in the Internet to provide various types of services. Typical websites are, for example, a portal site as an entrance when The Internet is used and websites on which web page information of various types of services are placed. To use these websites, conventionally, an information processing apparatus such as a personal computer having a communicating function is connected to the Internet and desired information is browsed by a web browser using input/output equipment such as a mouse, a keyboard, as pointing devices.

Although, at first, a personal computer having a mouse, a keyboard, and the like is mainly used as equipment for browsing information, the equipment is recently expanded to mobile terminals such as a mobile phone and a PDA having a small display screen size. However, when a display screen size is small, since a browsing document cannot be accommodated within the lateral width of the screen in which an image can be displayed, a frequent lateral scroll operation is required in browsing. To cope with the above problem, there are provided technologies for easily browsing a document even in a small mobile terminal having the small display screen size (for example, Non-Patent Documents 1 and 2).

In the technologies disclosed in Non-Patent Documents 1 and 2, when an HTML document is displayed, a table width and an image size are changed, and, when necessary, the layout of multiple columns is decomposed. Then, all the multiple columns are longitudinally connected again and reconstructed so that the lateral width of the table can be accommodated within a display possible size. With this arrangement, since the layout of the table is longitudinally increased, it can be avoided to perform a lateral scroll operation in browsing.

### [Non-Patent Document 1]

http://www.jp.opera.com/products/mobile/smallscreen/

### [Non-Patent Document 2]

http://www.access.co.jp/products/nf.html

### DISCLOSURE OF THE INVENTION

### Problems to be Solved by the Invention

However, the conventional technologies have the following drawbacks.

A conventional web browser is premised on that it is operated by a device such as a mouse capable of performing a direct pointing. Accordingly, when a browsing operation is performed only by keys disposed to a device such as a keyboard, a troublesome key operation is required. In particular, when it is assumed that information is browsed more vigorously hereinafter, it is apparent that a browsing operation becomes more troublesome than ever in a mobile phone having a smaller number of keys and having no device such as a mouse capable of performing a direct pointing and in consumer electronic equipment such as a television operated by a remote controller, with a conventional web browser.

Further, in the technologies disclosed in Non-Patent Documents 1 and 2, there is a possibility that the intention of a document creator cannot be transmitted because a document is displayed at a layout arrangement different from the intention of the document creator. When, for example, an HTML document, which is prepared using a visual layout composed of multiple columns having a links page on left, a text document at the center, and an advertisement on right, is displayed using the above technologies, the layout is reconstructed to a layout composed of vertically long columns sequentially connected from a left side. As a result, it is necessary to perform a considerably long vertical scroll to reach the text document, and thus a considerably long time is required to reach a target location. Further, there is also a problem in that it is difficult to find from which location a text document starts.

An object of the present invention, which was made in view of the above problems, is to provide a browsing technology capable of promptly moving to searching target information in a layout arrangement reflecting the intention of the creator of a browsing document.

Another object of the present invention is to provide a browsing technology capable of performing a browsing operation intuitively as well as a smaller number of times of operation without the need of a device capable of performing a direct pointing such as a mouse.

### Means for Solving the Problems

A first invention for solving the above problems is an information processing apparatus characterized by comprising display control means for displaying the entire information of a browsing target, the detailed information of the entire information of the browsing target, and the entire information of the information related to the information selected from the detailed information to a first display region and to a second display region by sequentially switching the information in response to the operation of first instruction means, which is associated with a target direction showing to trace information toward a browsing information as the target of a user and to the operation of second instruction means which is associated with a return direction of the target direction.

A second invention for solving the above problems is an information processing apparatus in the first invention characterized in that the display control means is arranged such that it causes the information displayed at the first display region to be capable of being selected in response to the operation of the first instruction means and causes the information displayed at the second display region to be capable of being selected in response to the operation of the second instruction means.

A third invention for solving the above problems is an information processing apparatus in the first or second invention characterized in that the display control means is arranged such that it can select the information displayed at the first display region or at the second display region by the operation of third or fourth instruction means.

A fourth invention for solving the above problems is an information processing apparatus in any of the first invention to the third invention characterized in that the entire information is arranged such that it is blocked and each block of the entire information can be selected.

A fifth invention for solving the above problems is an information processing apparatus in any of the first invention to the fourth invention characterized in that the first, second, third, and fourth instruction means are direction keys.

A sixth invention for solving the above problems is an information processing apparatus in any of the third invention to the fifth invention characterized in that the display control means is arranged such that it displays the information related to selected information to the first display region or to the second display region in cooperation with the selection of the information performed by the operation of the third or fourth instruction means in the first display region or the second display region.

A seventh invention for solving the above problems is an a browsing system characterized by comprising first instruction means, which is associated with a target direction showing to trace information toward a browsing information as the target of a user, second instruction means which is associated with a return direction of the target direction, and display control means for displaying the entire information of a browsing target, the detailed information of the entire information of the browsing target, and the entire information of the information related to the information selected from the detailed information to a first display region and to a second display region by sequentially switching the information in response to the operations of the first instruction means and the second instruction means.

An eighth invention for solving the above problems is a browsing system in the seventh invention characterized by comprising third or fourth instruction means for selecting the browsing information in the first display region or the second display region, wherein the display control means selectively displaying the browsing information displayed at the first display region or at the second display region in response to the operation of the third or fourth instruction means.

A ninth invention for solving the above problems is a browsing system in the seventh or eighth invention characterized in that the display control means is arranged such that it displays browsing target information relating to selected browsing target information to the second display region or to the first display region in cooperation with the selection of the browsing target information performed by the operation of the third or fourth key in the first display region or at the second display region.

A tenth invention for solving the above problems is a browsing system in any of the seventh invention to the ninth invention characterized in that the browsing information is a structured document.

An eleventh invention for solving the above problems is an information processing apparatus characterized by comprising display control means for displaying entire information, which is blocked and each block of which can be selected, detailed information, which is associated with each block of the entire information, and entire information related to the items of the detailed information to the first display region and to the second display region on a display screen by sequentially switching the information so as to correspond a direction showing to trace information toward a browsing information as the target of a user.

A twelfth invention for solving the above problems is an information processing apparatus in the eleventh invention characterized in that the display control means is arranged such that it switches the information to be displayed to the first display region and to the second display region in response to the operation of first instruction means, which is associated with a target direction showing to trace information toward a browsing information as the target of the user and the operation of second instruction means which is associated with a return direction of the target direction.

A thirteenth invention for solving the above problems is an information processing apparatus in the eleventh or twelfth invention characterized in that the display control means is arranged such that it causes the operation of the first instruction means to correspond to the first display region, causes the operation of the second instruction means to correspond to the second display region, causes the information displayed at the first display region to be capable of being selected in response to the operation of the first instruction means, and causes the information displayed at the second display region to be capable of being selected in response to the operation of the second instruction means.

A fourteenth invention for solving the above problems is an information processing apparatus in any of the eleventh invention to the thirteen invention characterized in that the display control means is arranged such that it can select the information displayed at the first display region or at the second display region by the operation of third or fourth instruction means.

A fifteenth invention for solving the above problems is an information processing apparatus in any of the eleventh invention to the fourteenth invention characterized in that the first, second, third, and fourth instruction means are direction keys.

A sixteenth invention for solving the above problems is an information processing apparatus characterized by comprising display control means for controlling a first display mode for displaying entire information, which is blocked and each block of which can be selected, and detailed information, from which the respective information of the entire information can be selected, and a second display mode for displaying the detailed information, from which the respective information can be selected, and the entire information related to the items of the detailed information by switching the first and second display modes in response to the operations of the first and second instruction means.

A seventeenth invention for solving the above problems is an information processing apparatus in the sixteenth invention characterized in that the display control means is arranged such that it displays the entire information, which is blocked and each block of which can be selected, in the first display region, displays detailed information, from which the respective information of the entire information can be selected, at the second display region, causes the blocks of entire information displayed at the first display region to be capable of being selected in response to the operation of the first instruction means associated with the first display region, and causes the information of the detailed information displayed at the second display region to be capable of being selected in response to the second instruction means associated with the second display region in the first display mode.

An eighteenth invention for solving the above problems is an information processing apparatus in the sixteenth invention or the seventeenth invention characterized in that the display control means displays detailed information, from which respective information can be selected, in the first display region, displays the entire information related to the information selected in the detailed information at the second display region, causes the respective information of the detailed information displayed at the first display region to be capable of being selected in response to the operation of the first instruction means associated with the first display region, and causes the entire information displayed at the second display region to be capable of being selected in response to the operation of the second instruction means associated with the second display region in the second display mode.

A nineteenth invention for solving the above problems is an information processing apparatus in any of the sixteenth invention to the eighteenth invention characterized in that the display control means is arranged such that it transits from the first display mode to the second display mode in response to the operation of the second instruction means and transits from the second display mode to the first display mode in response to the operation of the first instruction means.

A twentieth invention for solving the above problems is an information processing apparatus in any of the sixteenth invention to the nineteenth invention characterized in that the display control means is arranged such that it can select the information displayed at the first display region or at the second display region by the operation of third or fourth instruction means.

A twenty-first invention for solving the above problems is an information processing apparatus in any of the sixteenth invention to the twentieth invention characterized in that the first, second, third, and fourth instruction means are direction keys.

A twenty-second invention for solving the above problems is an information processing apparatus characterized by comprising display control means for displaying entire information, which is blocked and each block of which can be selected, detailed information from which the respective items of the entire information can be selected, and entire information related to the items of the detailed information to a first display region, a second display region, and a third display region by sequentially switching the information so that the information correspond to the search direction of a user.

A twenty-third invention for solving the above problems is an information processing apparatus, characterized by comprising display control means for performing a control such that entire blocked information is displayed to a first display region and the detailed information of the blocks of the entire information is displayed to a second display region, the second display region, in which the detailed information of a block selected by selection means is displayed, is placed in an active state, in which information can be selected by the selection means, in response to the instruction of instruction means, which is associated with a target direction showing to trace information toward a browsing information as the target of a user in an active state in which the first display region can select a block by the selection means and the instruction means is responded in an active state in which the second display region can select the respective information of detailed information by the selection means, and the entire information related to the information selected by the selection means is displayed to the first display region as well as the first display region is placed in an active state, and the detailed information of the related entire information is displayed to the second display region.

A twenty-fourth invention for solving the above problems is an information processing apparatus in the twenty-third invention characterized in that the display control means is arranged such that it displays the entire information or the detailed information which the user trace to the first display region or to the second display region in response to the instruction of the instruction means which is associated with a return direction of the target direction.

A twenty-fifth invention for solving the above problems is an information processing apparatus in the twenty-third invention or the twenty-fourth invention characterized in that the selection means and the instruction means are keys.

A twenty-sixth invention for solving the above problems is a computer readable medium having stored therein a program causes an information processing apparatus to perform a display control processing for displaying the entire information of a browsing target, the detailed information of the entire information of the browsing target, and the entire information of the information related to the information selected from the detailed information to a first display region and to a second display region by sequentially switching the information in response to the operation of first instruction means, which is associated with a target direction showing to trace information toward a browsing information as the target of a user and to the operation of second instruction means which is associated with a return direction of the target direction.

A twenty-seventh invention for solving the above problems is a computer readable medium in the twenty-sixth invention characterized in that the display control processing is a processing for causing the information displayed at the first display region to be capable of being selected in response to the operation of the first instruction means and causing the information displayed at the second display region to be capable of being selected in response to the operation of the second instruction means.

A twenty-eighth invention for solving the above problems is a computer readable medium in the twenty-sixth invention or the twenty seventh invention characterized in that the display control processing is arranged such that it can select the information displayed at the first display region or the second display region in response to the operation of third or fourth instruction means.

A twenty-ninth invention for solving the above problems is a computer readable medium in any of the twenty-sixth invention to the twenty-eighth invention characterized in that the program causes the information processing apparatus to perform a processing for blocking the entire information and selecting each block of the entire information.

A thirtieth invention for solving the above problems is a computer readable medium in any of the twenty-sixth invention to the twenty-ninth invention characterized in that the display control processing is a processing for displaying the information related to selected information to the first display region or to the second display region in cooperation with the selection of the information performed by the operation of the third or fourth instruction means in the first display region or the second display region.

A thirty-first invention for solving the above problems is a computer readable medium having stored therein a program causes an information processing apparatus to perform a display control processing for displaying entire information, which is blocked and each block of which can be selected, detailed information, which is associated with each block of the entire information, and entire information related to the items of the detailed information to the first display region and to the second display region on a display screen by sequentially switching the information so as to correspond a direction showing to trace information toward a browsing information as the target of a user.

A thirty-second invention for solving the above problems is a computer readable medium in the thirty-first invention characterized in that the display control processing is a processing for switching the information to be displayed to the first display region and to the second display region in response to the operation of first instruction means, which is associated with a target direction showing to trace information toward a browsing information as the target of the user and the operation of second instruction means which is associated with a return direction of the target direction.

A thirty-third invention for solving the above problems is a computer readable medium in the thirty-first invention or the thirty-second invention characterized in that the display control processing is a processing for causing the operation of the first instruction means to correspond to the first display region, causing the operation of the second instruction means to correspond to the second display region, causing the information displayed at the first display region to be capable of being selected in response to the operation of the first instruction means, and causing the information displayed at the second display region to be capable of being selected in response to the operation of the second instruction means.

A thirty-fourth invention for solving the above problems is a computer readable medium in any of the thirty-first invention to the thirty-third invention characterized in that the display control processing is a processing capable of selecting the information displayed at the first display region or at the second display region in response to the operation of third or fourth instruction means.

A thirty-fifth invention for solving the above problems is a computer readable medium having stored therein a program causes an information processing apparatus to perform a display control processing for controlling a first display mode for displaying entire information, which is blocked and each block of which can be selected, and detailed information, from which the respective information of the entire information can be selected, and a second display mode for displaying the detailed information, from which the respective information can be selected, and the entire information related to the items of the detailed information by switching the first and second display modes in response to the operations of the first and second instruction means.

A thirty-sixth invention for solving the above problems is a computer readable medium in the thirty-fifth invention characterized in that the display control processing is a processing for displaying the entire information, which is blocked and each block of which can be selected, in the first display region, displaying detailed information, from which the respective information of the entire information can be selected, at the second display region, causing the blocks of entire information displayed at the first display region to be capable of being selected in response to the operation of the first instruction means associated with the first display region, and causing the information of the detailed information displayed at the second display region to be capable of being selected in response to the second instruction means associated with the second display region in the first display mode.

A thirty-seventh invention for solving the above problems is a computer readable medium in the thirty-fifth invention or the thirty-sixth invention characterized in that the display control processing is a processing for displaying detailed information, from which respective information can be selected, in the first display region, displaying the entire information related to the information selected in the detailed information at the second display region, causing the respective information of the detailed information displayed at the first display region to be capable of being selected in response to the operation of the first instruction means associated with the first display region, and causing the entire information displayed at the second display region to be capable of being selected in response to the operation of the second instruction means associated with the second display region in the second display mode.

A thirty-eighth invention for solving the above problems is a computer readable medium in the thirty-seventh invention characterized in that the display control processing is a processing for transiting from the first display mode to the second display mode in response to the operation of the second instruction means and transiting from the second display mode to the first display mode in response to the operation of the first instruction means.

A thirty-ninth invention for solving the above problems is a computer readable medium in any of the thirty-fifth invention to the thirty-eighth invention characterized in that the display control processing is a processing capable of selecting the information displayed at the first display region or at the second display region by the operation of third or fourth instruction means.

A fortieth invention for solving the above problems is a computer readable medium having stored therein a program causes an information processing apparatus to perform display control means for displaying entire information, which is blocked and each block of which can be selected, detailed information from which the respective items of the entire information can be selected, and entire information related to the items of the detailed information to a first display region, a second display region, and a third display region by sequentially switching the information so that the information correspond to the search direction of a user.

A forty-first invention for solving the above problems is a computer readable medium having stored therein a program causes an information processing apparatus to perform a display control processing for performing a control such that entire blocked information is displayed to a first display region and the detailed information of the blocks of the entire information is displayed to the second display region, the second display region, in which the detailed information of a block selected by selection means is displayed, is placed in an active state, in which information can be selected by the selection means, in response to the instruction of instruction means, which is associated with a target direction showing to trace information toward a browsing information as the target of a user in an active state in which the first display region can select a block by the selection means, and the instruction means is responded in an active state in which the second display region can select the respective information of detailed information by the selection means, and the entire information related to the information selected by the selection means is displayed to the first display region as well as the first display region is placed in an active state, and the detailed information of the related entire information is displayed to the second display region.

A forty-second invention for solving the above problems is a computer readable medium in the forty-first invention characterized in that the display control processing is a processing for displaying the entire information or the detailed information which the user trace to the first display region or to the second display region in response to the instruction of the instruction means which is associated with the return direction of the target direction.

A forty-third invention for solving the above problems is a display control method of browsing information characterized by performing a control such that entire blocked information is displayed to a first display region and the detailed information of the blocks of the entire information is displayed to a second display region, the second display region, in which the detailed information of a block selected by selection means is displayed, is placed in an active state, in which information can be selected by the selection means, in response to the instruction of instruction means, which is associated with a target direction showing to trace information toward a browsing information as the target of a user in an active state in which the first display region can select a block by the selection means, and the instruction means is responded in an active state in which the second display region can select the respective information of detailed information by the selection means, and the entire information related to the information selected by the selection means is displayed to the first display region as well as the first display region is placed in an active state, and the detailed information of the related entire information is displayed to the second display region.

A forty-fourth invention for solving the above problems is a display control method in the forty-third invention characterized by displaying the entire information or the detailed information which the user trace to the first display region or to the second display region in response to the instruction of the instruction means which is associated with the return direction of the target direction.

The present invention shows a browsing document in an ordinary display mode shown in FIG. 2 and a zapping display mode shown in FIG. 3. The ordinary display mode is a mode for displaying an entire display screen (first display region) on which an HTML document in which a browsing target is blocked is shown in its entirety and a detail display screen (second display region) on which the detail of a blocked HTML document is displayed. The zapping display mode is a mode for displaying a detail screen (first display region) on which the detail of an HTML document as a browsing target is displayed and a thumbnail display screen (second display region) on which the thumbnail image of a link destination of the information selected from the HTML document is displayed.

The modes and the active display regions in each mode are switched by instruction means capable of visually discriminating the first display region and the second display region. For example, the second display region is associated with a direction in which a user moves toward target information, that is, to a proceeding direction in which the user performs a search as well as a right direction key is associated with the direction. In contrast, the first display region is associated with a direction in which the user returns to original information again, that is, to a return direction of the search of the user as well as a left key is associated with the direction.

As described above, the two instruction means permit to smoothly move from the entire display to the detailed display of a browsing document and from the detailed display to an entire display linked to the detailed display.

Further, the information in each active display region can be selected by the instruction means for instructing only an up/down movement.

Up, down, right, and left direction keys are exemplified as the instruction means.

### ADVANTAGES OF THE INVENTION

According to the present invention, even equipment having a small screen size can display a document that reflects the intention of the creator of a browsing document by providing the region for displaying a browsing document in its entirety and the region for displaying the detail of the browsing document and displaying them at the same time display. Further, the present invention can achieve an excellent advantage in that a reader can easily browse and search a document.

Further, the present invention can achieve an excellent advantage in that even with consumer electronic equipment such as a television, which has a smaller number of keys and is mainly operated by a remote controller, and with a mouse, which cannot be provided with direct pointing, one can browse and search a document intuitively as well as a smaller number of times of operation by integrally searching a browsing document and selecting information in the browsing document by the smaller number of instruction means.

### BRIEF DESCRIPTION OF THE DRAWINGS

FIG. 1 is a schematic view of a first embodiment;

FIG. 2 is a view showing an ordinary display mode;

FIG. 3 is a view showing a zapping display mode;

FIG. 4 is a view explaining an operation of the embodiment;

FIG. 5 is a view showing an example of a screen display of a browsing system in a second embodiment;

FIG. 6 is a view showing an example of the screen display of the browsing system in the second embodiment;

FIG. 7 is a view showing an example of the screen display of the browsing system in the second embodiment;

FIG. 8 is a view showing an example of the screen display of the browsing system in the second embodiment;

FIG. 9 is a view showing an example of the screen display of the browsing system in the second embodiment;

FIG. 10 is a view explaining the embodiment; and

FIG. 11 is a flowchart of a display operation.

### REFERENCE NUMERALS

1 Set top box
2 Display device
3 Remote controller
4 WWW server
5 Network

### BEST MODE FOR CARRYING OUT THE INVENTION

A first embodiment of the present invention will be explained.

The first embodiment will explain an example in which the present invention is applied to a set top box which can be connected to a network such as the Internet and a browsing operation is performed by a remote controller.

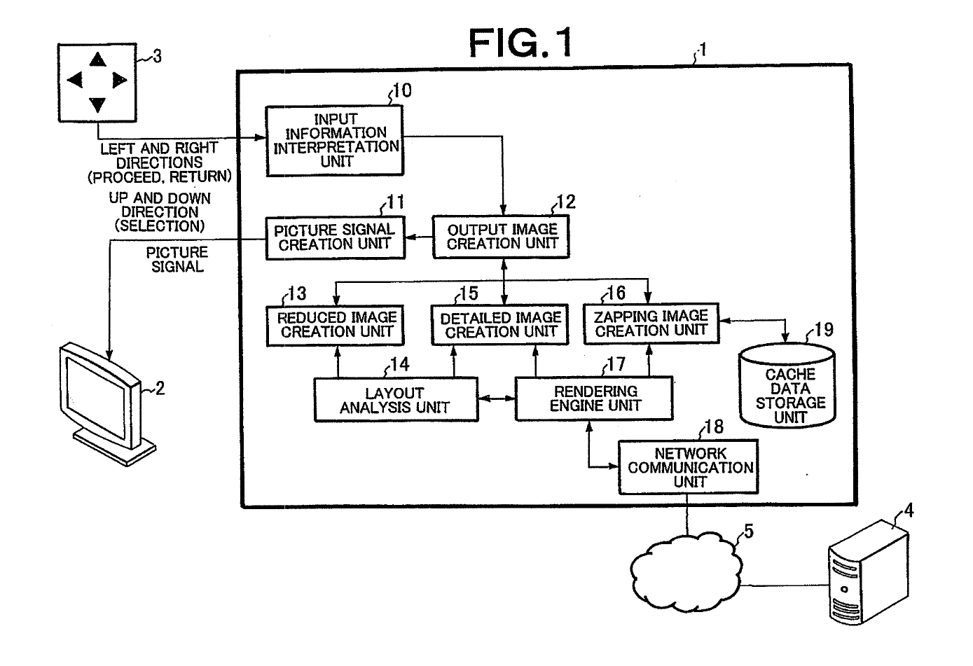

FIG. 1 is a schematic view of the first embodiment.

In FIG. 1, reference numeral 1 denotes the set top box as an information processing apparatus. Reference numeral 2 denotes a display device such as a TV on which a picture is displayed using a picture signal from the information processing apparatus 1 as an input. Reference numeral 3 denotes a remote controller as an instruction means for operating the set top box 1. Reference numeral 4 denotes a WWW server in which browsing documents are stored. Reference numeral 5 denotes a network such as The Internet to which the set top box 1 and the WWW server 4 are connected.

The set top box 1 has an input information interpretation unit 10, a picture signal creation unit 11, an output image creation unit 12, a reduced image creation unit 13, a layout analysis unit 14, a detailed image creation unit 15, a zapping image creation unit 16, a rendering engine unit 17, a network communication unit 18, and a cache data storage unit 19.

The remote controller 3 is an instruction means for performing a document browsing operation in the set top box 1. In the embodiment, the browsing operation can be performed by four up, down, left, and right direction keys of the remote controller.

The input information interpretation unit 10 receives an operation signal from any of the four up, down, left, and right direction keys, detects any of the keys is depressed, and outputs a result of detection to the output image creation unit 12.

The rendering engine unit 17 reads HTML data through the network 5, and expresses again the data in an appropriate format according to the condition and the specific rule attached to the data.

The layout analysis unit 14 receives the output from the rendering engine unit 17, analyzes a layout, and blocks a document. As a method of blocking the document, it may be blocked each predetermined several lines, or other method may be used.

The reduced image creation unit 13 creates a reduced image of the blocked document from the layout analysis unit 14.

The detailed image creation unit 15 receives the output from the rendering engine unit 17 and aligns the detailed information of an HTML document to the size of a screen on which the detailed image can be displayed so that no lateral scroll occurs. A return processing according to a screen size and the like, for example, are exemplified as a processing for preventing occurrence of the lateral scroll.

The zapping image creation unit 16 captures the output from the rendering engine unit 17 and creates a thumbnail image. The created zapping image is cached to the cache data storage unit 19 to increase a processing speed.

The output image creation unit 12 disposes two images or two information of the reduced image from the reduced image creation unit 13, the detailed information from the detailed image creation unit 15, and the thumbnail image from the zapping image creation unit 16 to two display regions and outputs them based on the instruction from the input information interpretation unit 10.

The picture signal creation unit 11 receives the output from the output image creation unit 12, converts the output to a signal suitable for display on the display device 2, and outputs the signal.

Next, display modes displayed on the display device 2 by the set top box 1 of the embodiment will be explained.

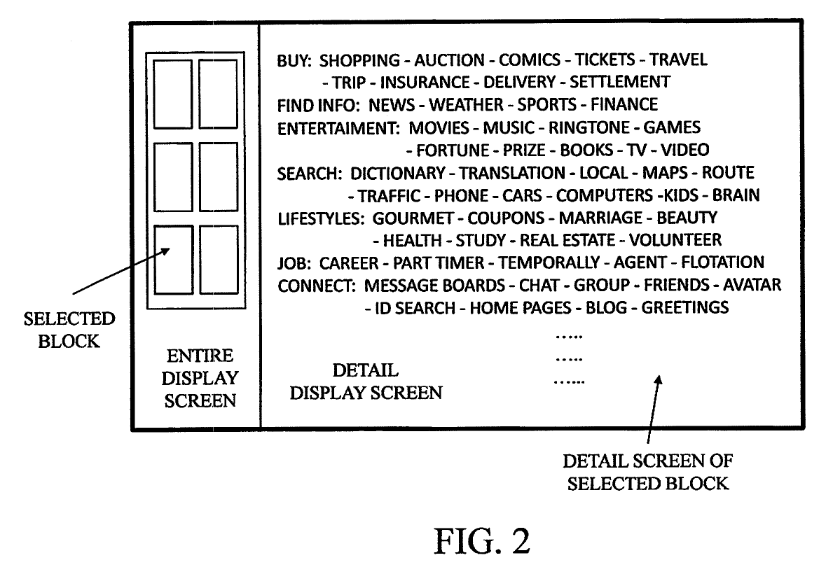

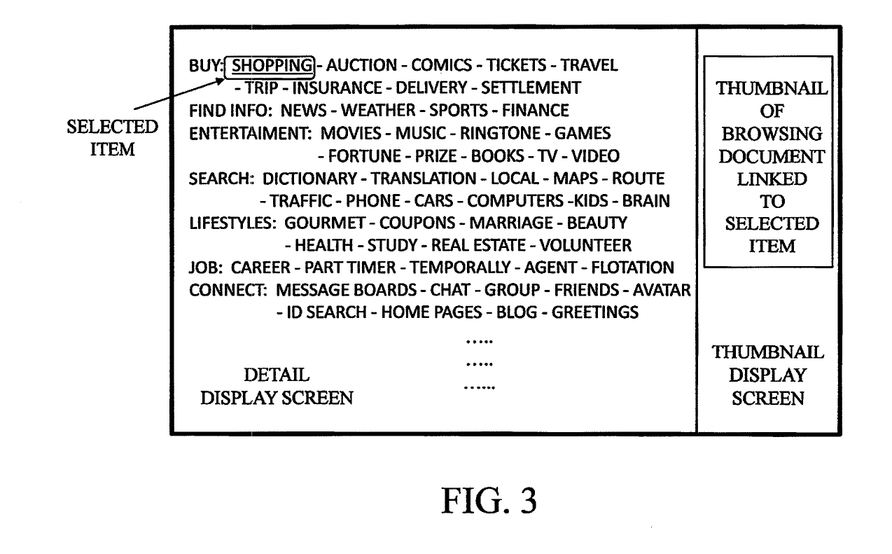

FIG. 2 and FIG. 3 are views showing the display modes of the embodiment. FIG. 2 shows an ordinary display mode, and FIG. 3 shows a zapping display mode.

The ordinary display mode shown in FIG. 2 is a mode in which an entire display screen (first display region), in which an entire blocked HTML document is displayed, and a detail display screen (second display region), in which the detailed information in a block selected from the HTML document is displayed, are displayed.

Further, the zapping display mode shown in FIG. 3 is a mode in which a detail screen (first display region), on which the detail of an HTML document as a browsing target is displayed, and a thumbnail display screen (second display region), on which the thumbnail image of a link destination of the information selected from the HTML document is displayed, are displayed.

Active display regions in each mode can be switched by depressing the left and right direction keys of the remote controller 3. Specifically, the first display region in each mode is associated with the left direction key, and the second display region therein is associated with the right direction key. That is, the second display region is disposed in a direction showing that a user traces information toward the browsing information as the target of the user, and the right direction key is associated with the second display region. Further, the first display region is disposed in a direction in which the user returns to a document browsed by him or her, and the left direction key is associated with the first display region. Information in an active display region is selected using the up and down direction keys. That is, depression of the up or down direction key in the active display region causes the information of a selection target to be sequentially inverted, thereby information in the region can be selected.

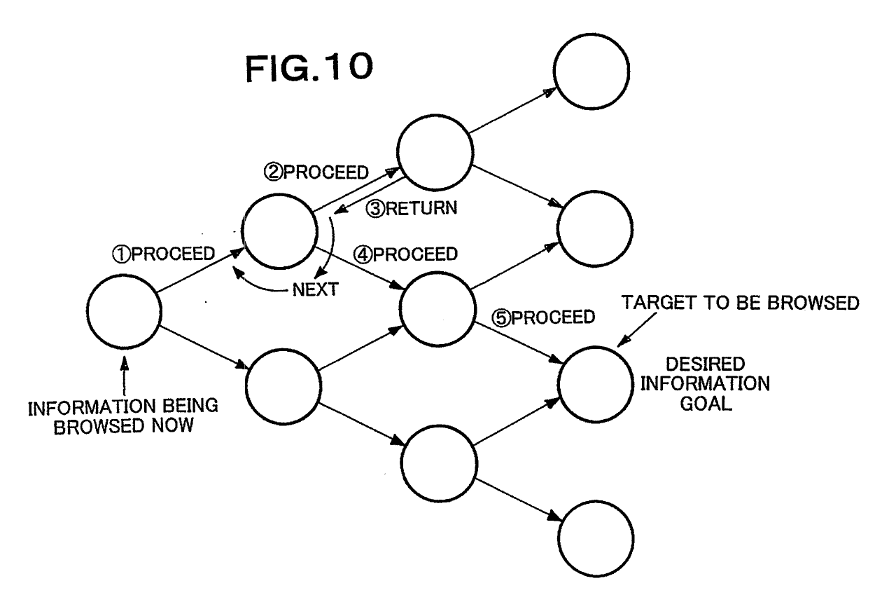

As shown in FIG. 10, in an information browsing process from, for example, the information being browsed now to desired information, when the user moves from the information being browsed now to information (1), the user proceeds while depressing the right direction key which is associated with the direction in which the user traces information to target browsing information. Further, when the user moves from information (1) to information (2), the user proceeds while depressing the right direction key. Further, when the information (2) is not the information desired by the user, the user can return to original information by depressing the right and left keys which are associated with a return direction opposite to the direction in which the user traces information toward the target browsing information. Further, when the user proceeds from the information (1) to information (4) different from the information (1), the user can sequentially selects information by depressing, for example, the down direction key in the state that he or she browses the information (1). The user can move to the information (4) corresponding to selected information by depressing the right direction key. Then, the user can reach the desired information from the information (4) by depressing the right direction key from the information (4). As described above, the embodiment is characterized in that the instruction means are integrated to obtain information toward the target browsing information.

When a reader starts the browsing system, a previously registered portal site, for example, is displayed. At the time, the top page of the portal site is analyzed and blocked by the layout analysis unit 14. The blocked top page is displayed to the entire display screen (first display region). Further, the detailed information of the uppermost block of the blocked top page is displayed on the detail display screen (second display region) in an easy-to-read character size as well as in a layout reconstructed to make it unnecessary to perform a lateral scroll. Then, at the beginning of start, the entire display screen (first display region) is made to an active screen, and a block in the entire display screen (first display region) is selected by operating the up and down direction keys for selecting the block.

The active entire display screen (first display region) is switched to the detail display screen (second display region) by depressing the right direction key which is associated with the detail display screen (second display region). With this operation, the detail display screen (second display region) is made active, and the information displayed on the detail display screen (second display region) can be selected.

Further, when it is desired to continue a search in the detailed information displayed on the active detail display screen (second display region), the ordinary mode is switched to the zapping display mode shown in FIG. 3 by depressing the right direction key which is a key for continuing the search. As a result, the detail display screen, on which the detailed information is displayed, is displayed at the first display region, and the thumbnail image of the entire browsing document of a link destination of the information selected from the detailed information is created by the zapping image creation unit 16 and displayed at the second display region. With this arrangement, the second display region, in which the thumbnail image is displayed, is made active.

When the reader returns to the original document browsed by him or her, he or she depresses the left direction key. With this operation, the screen of the first display region can be made active. That is, when the detail display screen displayed at the second display region is active in the ordinary display mode, the user can make the screen of the first display region active by depressing the left direction key. Further, when the thumbnail display screen is made active in the zapping display mode, the zapping display mode is switched to the ordinary display mode by depressing the left direction key. As a result, the detail screen is displayed at the second display region, and further the entire display screen is displayed at the first display region.

As described above, the present invention is characterized in that a screen can be browsed by the four left, right, up, and down direction keys.

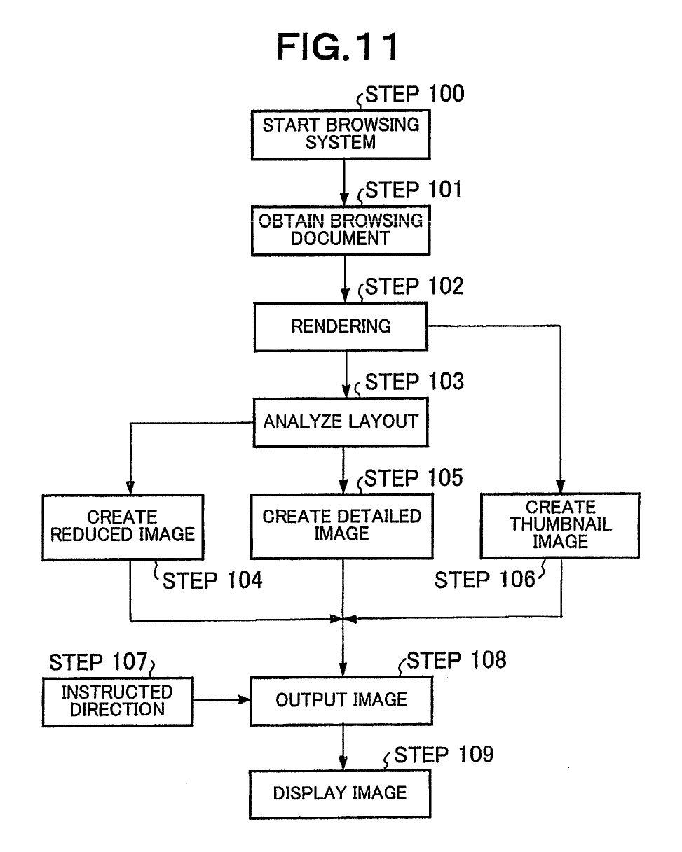

The display operation described above will be explained using a flowchart. FIG. 11 is a flowchart of the display operation.

First, when the browsing system starts (Step 100), a browsing document is obtained through the network 5 (Step 101).

The obtained browsing document is expressed in an appropriate format by the rendering engine unit 17 according to the condition and the specific rule attached to data (Step 102). Then, the browsing document is subjected to a layout analysis and blocked (Step 103), thereby a reduced image and a detailed image are created (Steps 104, 105). Further, a thumbnail image is created by capturing the output from the rendering engine unit 17 (Step 106). These images are input to the output image creation unit 12.

When any direction key of the four direction keys is depressed, it is detected by the input information interpretation unit 10 (Step 107). As a result of detection, an image in conformity with the direction key is output from the output image creation unit 12 (Step 108). Then, browsing documents are displayed at the first and the second display regions of the display device 2 (Step 109).

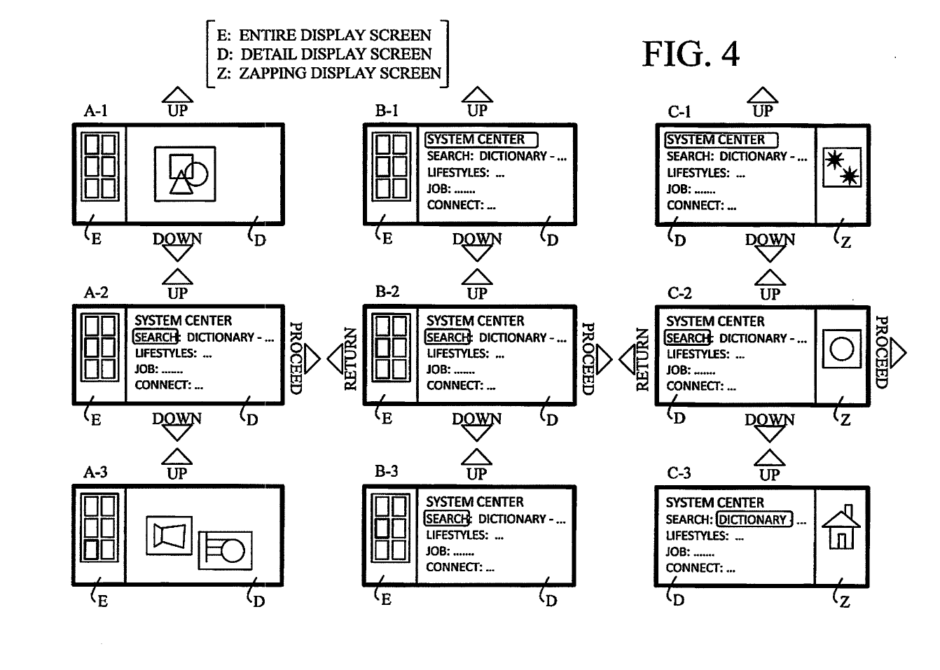

Subsequently, a specific operation will be explained using a transition view of FIG. 4.

First, a state B-2 is a state in which the previously registered portal site is displayed. The top page of the portal site is analyzed and blocked by the layout analysis unit 14, and the blocked top page is displayed on the entire display screen (the first display region). Further, the detailed information of a second block of the blocked top page is displayed on the detail display screen (the second display region) in an easy-to-read character size as well as in a layout reconstructed to make it unnecessary to perform a lateral scroll. Note that, the active screen in this state is the detail display screen (the second display region).

In the state B-2, when the up direction key is depressed once, the detailed information just above the present detailed information can be selected (a state B-1). Then, the state B-2 is returned from the state B-1 by depressing the down direction key once.

When the down direction key is depressed once in the state B-2, the detailed information just below the present detailed information can be selected (a state B-3). In the embodiment, since the layout of the detailed information is arranged so that no lateral scroll occurs, the selected information is information located on a side of the information selected in the state B-2. Then, the state B-2 is returned from the state B-3 by depressing the up direction key once.

When the right direction key is depressed once in the state B-2, the display mode is switched from the ordinary display mode to the zapping display mode. With this operation, the detailed information is switched to and displayed at the first display region, and the thumbnail image of a link destination of the selected image is displayed at the second display region (a state C-2).

When the up direction key is depressed once in the state C-2, the thumbnail image of a link destination of the information just above the information selected in the detail display screen is displayed at the second display region (a state C-1). The state C-1 is returned to the state C-2 by depressing the down direction key once in the state C-1.

When the down direction key is depressed once in the state C-2, the thumbnail image of a link destination of the information located just below the information selected on the detail display screen is displayed at the second display region (a state C-3). The state C3 is returned to the state C-2 by depressing the up direction key once in the state C-3.

When the left direction key is depressed once in the state C-2, the display mode is switched from the zapping display mode to the ordinary display mode. As a result, the detailed information is switched to and displayed at the second display region, and the entire information of the selected detailed information is displayed at the first display region, that is, the state C-2 is returned to the state B-2.

When the left direction key is depressed once in the state B-2, the active screen (region) is switched from the detail display screen (the second display region) to the entire display screen (the first display region) (state A-2). With this operation, the respective blocks of the entire display displayed on the entire display screen (the first display region) can be selected.

In the state A-2, an upper block can be selected by depressing the up direction key once. At the same time, the detailed information of a selected block is displayed on the detail display screen (the second display region) (the state A-1). The state A-1 is returned to the state A-2 by depressing the down direction key once in the state A-1.

When the down direction key is depressed once in the state A-2, a lower block can be selected. At the same time, the detailed information of a selected block is displayed on the detail display screen (the second display region) (state A-3). The state A-3 can be returned to the state A-2 by depressing the up direction key once in the state A-3.

As described above, in the embodiment, the browsing operation is integrated to the four left, right, up, and down direction keys, and further these direction keys are associated with the regions in which browsing information are displayed and to information selecting directions. Accordingly, an operation and a screen movement can be realized intuitively as well as easily.

Further, the embodiment is arranged such that a browsing document is divided into a plurality of blocks so that a browsing location can be selected in a block unit, thereby the detailed information of a selected block is displayed simultaneously with the entire display of the browsing document. Accordingly, the reader can browse the correct layout and the detailed information of a browsing document intended by a creator at the same time. Further, the reader can browse the detailed information in an easy-to-observe layout without the need of a lateral scroll.

Note that although the embodiment exemplifies the Web (HTML) as a browsing document, the embodiment is not limited thereto, and a display-possible XML document using a style sheet of an electronic book, and a DTD may be employed.

Further, although the embodiment exemplifies the four direction keys of the remote controller as the instruction means, the embodiment is not limited thereto, and direction keys or buttons of a keyboard, audio instructions making use of audio recognition, and the like may be employed as long as they can specify four directions.

Further, the output image creation unit 12, the reduced image creation unit 13, the layout analysis unit 14, the detailed image creation unit 15, the zapping image creation unit 16, and the rendering engine unit 17 of the set top box may be composed of a CPU and operated by a program.

A second embodiment will be explained.

In the second embodiment, a function capable of previously registering a plurality of top pages and the like is added to the first embodiment so that they are displayed when a browsing system is started. That is, a function corresponding to the favorite function of a Web browser is added.

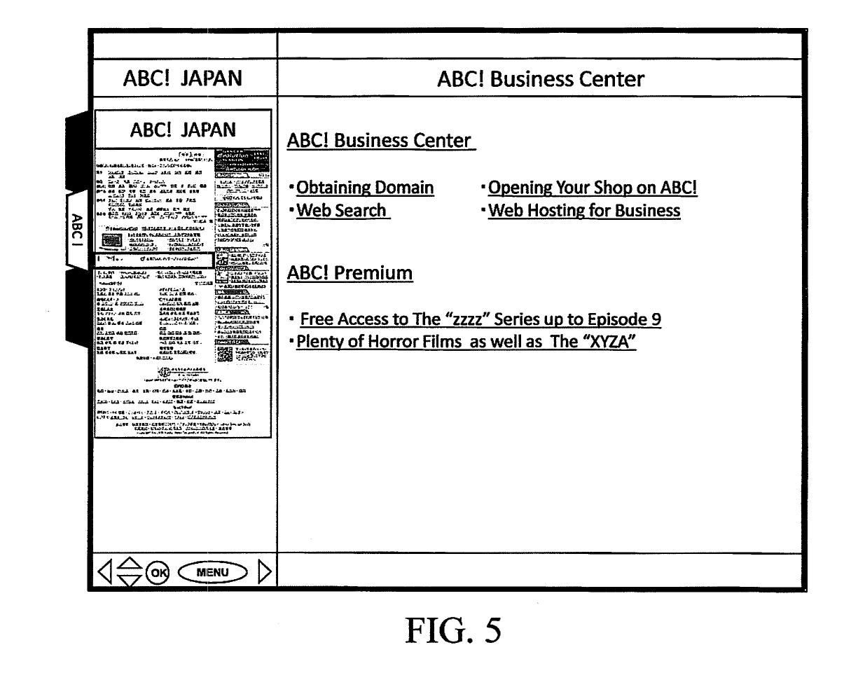

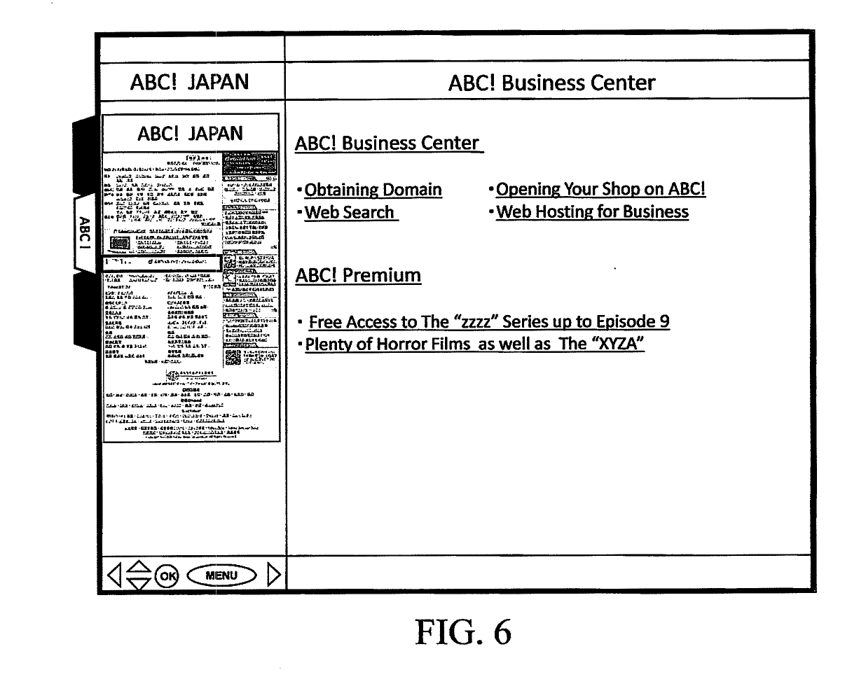

FIG. 5 and FIG. 6 are views showing examples of a screen display of the browsing system in the second embodiment. In FIG. 5, tabs for showing the top pages of previously registered portal sites are disposed to the left side of an entire display screen (a first display region) in an ordinary display mode. As shown in FIG. 6, when a left direction key is depressed at the time the entire display screen (the first display region) is made active, the respective tabs are focused (made active) and can be selected in the transition to the tabs. In the selection of the tabs, a desired tab can be selected by depressing up and down direction keys when the tabs are focused (made active). When the desired tab is selected, the top page of the portal site corresponding to the tab is displayed on the entire display screen (the first display region), and the detailed information of a block portion of the entire display is displayed on a detail display screen (second display region).

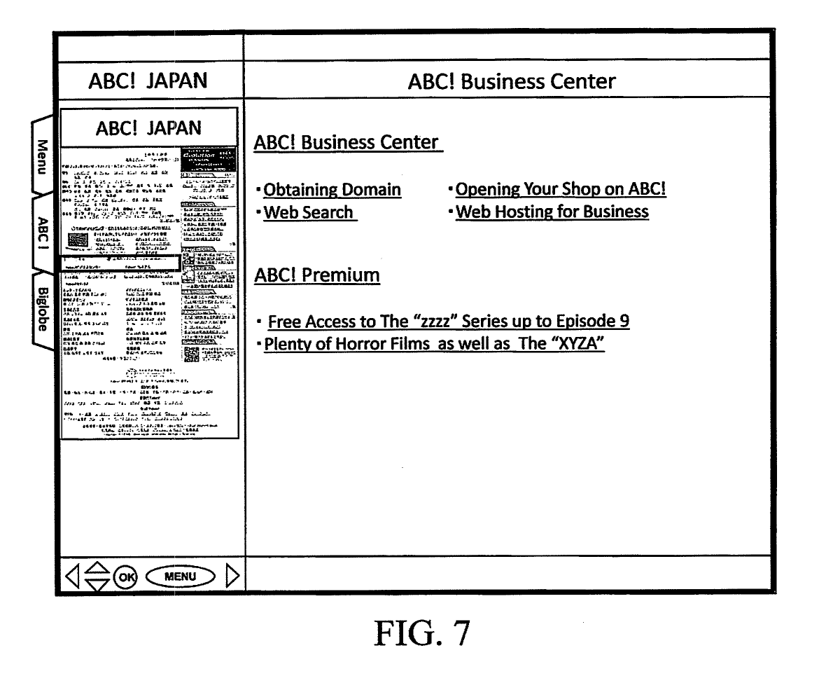

Note that the tabs may be associated with not only the top pages of the portal sites but also with the menus of a set top box as shown in FIG. 7.

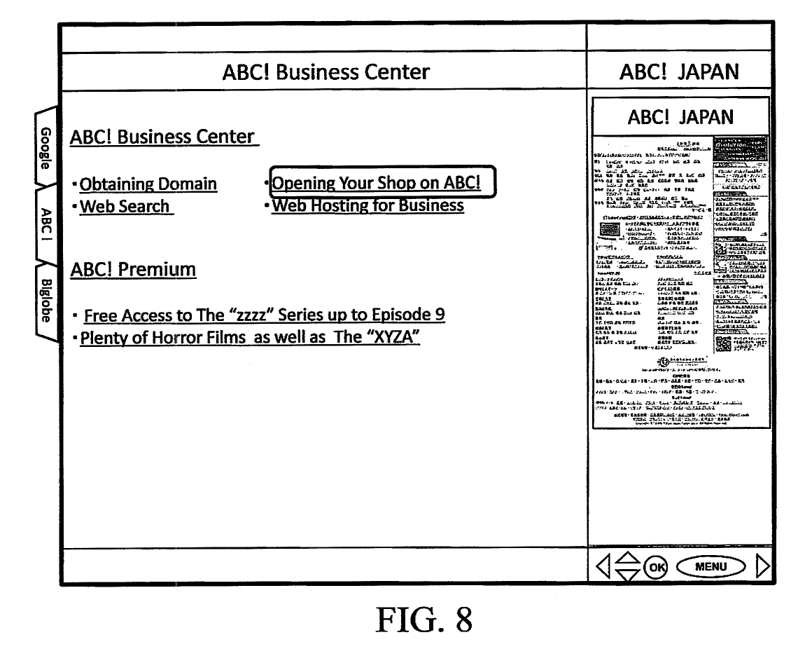

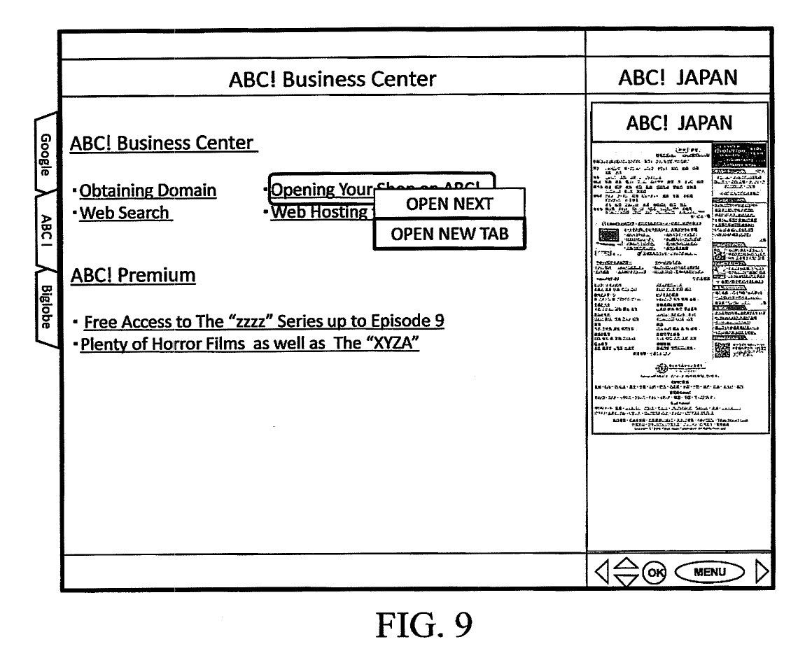

Further, as a method of adding a new tab, a left direction key is depressed when a thumbnail display screen is made active in a zapping display mode as shown in FIG. 8. With this operation, a context menu for adding a tab to the information focused in a detail display screen is displayed as shown in FIG. 9. When “open new tab” of the menu is selected, the information of a link destination of the tab, that is, a link destination displayed on the thumbnail display screen is added to the tab.

1. An information processing apparatus comprising:
display control means for displaying entire information of a browsing target, detailed information of the entire information of the browsing target, and entire information of information related to information selected from the detailed information at a first display region and at a second display region by sequentially switching the information in response to operation of first instruction means which is associated with a target direction showing to trace information toward a browsing information as a target of a user and to an operation of second instruction means which is associated with a return direction of the target direction.

2. An information processing apparatus according to claim 1, wherein the display control means arranges information displayed at the first display region to being selectable in response to an operation of the first instruction means and arranges information displayed at the second display region to being selectable in response to the operation of the second instruction means.

3. An information processing apparatus according to claim 1, wherein the display control means is enabled to select information displayed at the first display region or at the second display region by operation of third or fourth instruction means.

4. An information processing apparatus according to claim 1, wherein the entire information is blocked and each of the blocks of the entire information can be selected.

5. An information processing apparatus according to claim 1, wherein each of the first, second, third, and fourth instruction means is a direction key.

6. An information processing apparatus according to claim 1, wherein the display control means displays information related to selected information at the first display region or at the second display region in cooperation with the selection of the information performed by operation of the third or fourth instruction means at the first display region or the second display region.

7. A browsing system comprising:
first instruction means which is associated with a target direction showing to trace information toward a browsing information as a target of a user;
second instruction means which is associated with a return direction of the target direction; and
display control means for displaying entire information of a browsing target, detailed information of the entire information of the browsing target, and entire information of information related to information selected from the detailed information at a first display region and at a second display region by sequentially switching the information in response to operation of the first instruction means and the second instruction means.

8. A browsing system according to claim 7, further comprising:
third or fourth instruction means for selecting browsing information displayed at the first display region or the second display region;
wherein the display control means selectively displaying the browsing information displayed at the first display region or at the second display region in response to the operation of the third or fourth instruction means.

9. A browsing system according to claim 7, wherein the display control means displays browsing target information related to selected browsing target information at the second display region or at the first display region in cooperation with the selection of the browsing target information performed by operation of the third or fourth key at the first display region or the second display region.

10. A browsing system according to claim 7, wherein the browsing information is a structured document.

11. An information processing apparatus comprising:
display control means for displaying entire information which is blocked and each block of which can be selected, detailed information which is associated with each block of the entire information, and entire information related to items of the detailed information at the first display region and at the second display region on a display screen by sequentially switching the information so as to correspond a direction showing to trace information toward a browsing information as the target of a user.

12. An information processing apparatus according to claim 11, wherein the display control means switches information to be displayed at the first display region and at the second display region in response to operation of first instruction means which is associated with a target direction showing to trace information toward a browsing information as a target of the user and operation of second instruction means which is associated with a return direction of the target direction.

13. An information processing apparatus according to claim 11, wherein the display control means: associates operation of the first instruction means with the first display region; associates operation of the second instruction means with the second display region; arranges information displayed at the first display region to being selectable in response to the operation of the first instruction means; and arranges information displayed at the second display region to being selectable in response to operation of the second instruction means.

14. An information processing apparatus according to claim 11, wherein the display control means is enabled to select information displayed at the first display region or at the second display region by operation of third or fourth instruction means.

15. An information processing apparatus according to claim 11, wherein each of the first, second, third, and fourth instruction means is a direction key.

16. An information processing apparatus comprising:
display control means for controlling: a first display mode for displaying entire information which is blocked and each block of which can be selected and detailed information from which respective information of the entire information can be selected; and a second display mode for displaying the detailed information from which the respective information can be selected and entire information related to items of the detailed information by switching the first and second display modes in response to operations of the first and second instruction means.

17. An information processing apparatus according to claim 16, wherein the display control means is arranged such that it displays the entire information, which is blocked and each block of which can be selected, in the first display region, displays detailed information, from which the respective information of the entire information can be selected, at the second display region, causes the blocks of entire information displayed at the first display region to be capable of being selected in response to the operation of the first instruction means associated with the first display region, and causes the information of the detailed information displayed at the second display region to be capable of being selected in response to the second instruction means associated with the second display region in the first display mode.

18. An information processing apparatus according to claim 16, wherein the display control means displays detailed information, from which respective information can be selected, in the first display region, displays the entire information related to the information selected in the detailed information at the second display region, causes the respective information of the detailed information displayed at the first display region to be capable of being selected in response to the operation of the first instruction means associated with the first display region, and causes the entire information displayed at the second display region to be capable of being selected in response to the operation of the second instruction means associated with the second display region in the second display mode.

19. An information processing apparatus according to claim 16, wherein the display control means is arranged such that it transits from the first display mode to the second display mode in response to the operation of the second instruction means and transits from the second display mode to the first display mode in response to the operation of the first instruction means.

20. An information processing apparatus according to claim 16, wherein the display control means is arranged such that it can select the information displayed at the first display region or at the second display region in response to the operation of third or fourth instruction means.

21. An information processing apparatus according to claim 16, characterized in that the first, second, third, and fourth instruction means are direction keys.

22. An information processing apparatus comprising:
display control means for displaying entire information, which is blocked and each block of which can be selected, detailed information from which the respective items of the entire information can be selected, and entire information related to the items of the detailed information to a first display region, a second display region, and a third display region by sequentially switching the information so that the information correspond to the search direction of a user.

23. An information processing apparatus comprising,
display control means for performing a control such that:
entire blocked information is displayed to a first display region and the detailed information of the blocks of the entire information is displayed to a second display region;
the second display region, in which the detailed information of a block selected by selection means is displayed, is placed in an active state, in which information can be selected by the selection means, in response to the instruction of instruction means, which is associated with a target direction showing to trace information toward a browsing information as the target of a user in an active state in which the first display region can select a block by the selection means; and
the instruction means is responded in an active state in which the second display region can select the respective information of detailed information by the selection means, and the entire information related to the information selected by the selection means is displayed to the first display region as well as the first display region is placed in an active state, and the detailed information of the related entire information is displayed to the second display region.

24. An information processing apparatus according to claim 23, wherein the display control means is arranged such that it displays the entire information or the detailed information which the user trace to the first display region or to the second display region in response to the instruction of the instruction means which is associated with a return direction of the target direction.

25. An information processing apparatus according to claim 23, wherein the selection means and the instruction means are keys.

26. A computer readable medium having stored therein a program causes an information processing apparatus to perform a display control processing for displaying the entire information of a browsing target, the detailed information of the entire information of the browsing target, and the entire information of the information related to the information selected from the detailed information to a first display region and to a second display region by sequentially switching the information in response to the operation of first instruction means, which is associated with a target direction showing to trace information toward a browsing information as the target of a user and to the operation of second instruction means which is associated with a return direction of the target direction.

27. A computer readable medium according to claim 26, wherein the display control processing is a processing for causing the information displayed at the first display region to be capable of being selected in response to the operation of the first instruction means and causing the information displayed at the second display region to be capable of being selected in response to the operation of the second instruction means.

28. A computer readable medium according to claim 26, wherein the display control processing is arranged such that it can select the information displayed at the first display region or the second display region in response to the operation of third or fourth instruction means.

29. A computer readable medium according to claim 26, wherein the program causes the information processing apparatus to perform a processing for blocking the entire information and selecting each block of the entire information.

30. A computer readable medium according to claim 26, wherein the display control processing is a processing for displaying the information related to selected information to the second display region or to the first display region in cooperation with the selection of the information performed by the operation of the third or fourth instruction means in the first display region or the second display region.

31. A computer readable medium having stored therein a program causes an information processing apparatus to perform a display control processing for displaying entire information, which is blocked and each block of which can be selected, detailed information, which is associated with each block of the entire information, and entire information related to the items of the detailed information to the first display region and to the second display region on a display screen by sequentially switching the information so as to correspond a direction showing to trace information toward a browsing information as the target of a user.

32. A computer readable medium according to claim 31, wherein the display control processing is a processing for switching the information to be displayed to the first display region and to the second display region in response to the operation of first instruction means, which is associated with a target direction showing to trace information toward a browsing information as the target of the user and the operation of second instruction means which is associated with a return direction of the target direction.

33. A computer readable medium according to claim 31, wherein the display control processing is a processing for causing the operation of the first instruction means to correspond to the first display region, causing the operation of the second instruction means to correspond to the second display region, causing the information displayed at the first display region to be capable of being selected in response to the operation of the first instruction means, and causing the information displayed at the second display region to be capable of being selected in response to the operation of the second instruction means.

34. A computer readable medium according to claim 31, wherein the display control processing is a processing capable of selecting the information displayed at the first display region or at the second display region by the operation of third or fourth instruction means.

35. A computer readable medium having stored therein a program causes an information processing apparatus to perform a display control processing for controlling a first display mode for displaying entire information, which is blocked and each block of which can be selected, and detailed information, from which the respective information of the entire information can be selected, and a second display mode for displaying the detailed information, from which the respective information can be selected, and the entire information related to the items of the detailed information by switching the first and second display modes in response to the operations of the first and second instruction means.

36. A computer readable medium according to claim 35, wherein the display control processing is a processing for displaying the entire information, which is blocked and each block of which can be selected, in the first display region, displaying detailed information, from which the respective information of the entire information can be selected, at the second display region, causing the blocks of entire information displayed at the first display region to be capable of being selected in response to the operation of the first instruction means associated with the first display region, and causing the information of the detailed information displayed at the second display region to be capable of being selected in response to the second instruction means associated with the second display region in the first display mode.

37. A computer readable medium according to claim 35, wherein the display control processing is a processing for displaying detailed information, from which respective information can be selected, in the first display region, displaying the entire information related to the information selected in the detailed information at the second display region, causing the respective information of the detailed information displayed at the first display region to be capable of being selected in response to the operation of the first instruction means associated with the first display region, and causing the entire information displayed at the second display region to be capable of being selected in response to the operation of the second instruction means associated with the second display region in the second display mode.

38. A computer readable medium according to claim 35, wherein the display control processing is a processing for transiting from the first display mode to the second display mode in response to the operation of the second instruction means and transiting from the second display mode to the first display mode in response to the operation of the first instruction means.

39. A computer readable medium according to claim 35, wherein the display control processing is a processing capable of selecting the information displayed at the first display region or at the second display region by the operation of third or fourth instruction means.

40. A computer readable medium having stored therein a program causes an information processing apparatus to perform display control means for displaying entire information, which is blocked and each block of which can be selected, detailed information from which the respective items of the entire information can be selected, and entire information related to the items of the detailed information to a first display region, a second display region, and a third display region by sequentially switching the information so that the information correspond to the search direction of a user.

41. A computer readable medium having stored therein a program causes an information processing apparatus to perform a display control processing for performing a control such that:
entire blocked information is displayed to a first display region and the detailed information of the blocks of the entire information is displayed to the second display region;
the second display region, in which the detailed information of a block selected by selection means is displayed, is placed in an active state, in which information can be selected by the selection means, in response to the instruction of instruction means, which is associated with a target direction showing to trace information toward a browsing information as the target of a user in an active state in which the first display region can select a block by the selection means; and
the instruction means is responded in an active state in which the second display region can select the respective information of detailed information by the selection means, and the entire information related to the information selected by the selection means is displayed to the first display region as well as the first display region is placed in an active state, and the detailed information of the related entire information is displayed to the second display region.

42. A computer readable medium according to claim 41, wherein the display control processing is a processing for displaying the entire information or the detailed information which the user trace to the first display region or to the second display region in response to the instruction of the instruction means which is associated with the return direction of the target direction.

43. A display control method of browsing information, characterized by performing a control such that:
entire blocked information is displayed to a first display region and the detailed information of the blocks of the entire information is displayed to a second display region;
the second display region, in which the detailed information of a block selected by selection means is displayed, is placed in an active state, in which information can be selected by the selection means, in response to the instruction of instruction means, which is associated with a target direction showing to trace information toward a browsing information as the target of a user in an active state in which the first display region can select a block by the selection means; and
the instruction means is responded in an active state in which the second display region can select the respective information of detailed information by the selection means, and the entire information related to the information selected by the selection means is displayed to the first display region as well as the first display region is placed in an active state, and the detailed information of the related entire information is displayed to the second display region.

44. A display control method according to claim 43, characterized by displaying the entire information or the detailed information which the user trace to the first display region or to the second display region in response to the instruction of the instruction means which is associated with the return direction of the target direction.
